(19) United States
(12) Patent Application Publication
(10) Pub. No.: US 2023/0413733 A1
(43) Pub. Date: Dec. 28, 2023

(54) FRAMEWORK FOR MONITORING, CONTROLLING, REPORTING, RECORDING AND DATA AUTHENTICATION OF GRAIN STORAGE CONTAINER SYSTEMS

(71) Applicant: HABER TECHNOLOGIES, INC., Ames, IA (US)

(72) Inventors: ERIC G. HARWEGER, AMES, IA (US); DILLON G. HURD, AMES, IA (US)

(21) Appl. No.: 18/215,102

(22) Filed: Jun. 27, 2023

Related U.S. Application Data
(60) Provisional application No. 63/355,984, filed on Jun. 27, 2022.

(51) Int. Cl. A01F 25/16

(52) U.S. Cl. CPC A01F 25/16

(57) ABSTRACT

A framework for modeling performance of bin systems in precision agriculture settings, and grain stored in containers, collects information on auxiliary devices, the grain, and the container using both wireless sensors built into devices and transient sensors that are embedded within and move with the grain. Machine learning-based models are developed and applied within this framework for performing management functions such as monitoring for failure or malfunction, and controlling and adjusting bin systems in response to sensed conditions. Information collected and processed within this framework is stored and tokenized in a secure ledger for tracking, transactions, verification, and authentication of crop value and carbon emission-related data.

### CROSS-REFERENCE TO RELATED PATENT APPLICATION(S)

This patent application claims priority to U.S. provisional patent application 63/355,984, filed on Jun. 27, 2022, the contents of which are incorporated in its entirety herein. In accordance with 37 C.F.R. § 1.76, a claim of priority is included in an Application Data Sheet filed concurrently herewith.

### FIELD OF THE INVENTION

The present invention relates to crop conditioning systems in precision agriculture. Specifically, the present invention relates to automated operation of, and data collection attendant to, in-bin drying technologies that include, but are not limited to, a stirator used in crop storage containers to move and dry grain within such a container, and an approach to utilizing sensor data in crop conditioning systems for tracking and verifying grain data including the presence of grain, the condition of grain, and the inputs and outputs related to the carbon.

### BACKGROUND OF THE INVENTION

Many existing crop storage containers (which may also be referred to herein as simply containers, or bins) are configured with stirring systems, commonly known as StirAtors or stirators, which operate to dry grain within a container by mixing the grain, by rotating one or more augers typically positioned vertically within the container to promote a uniform distribution. The augers mix drier grain at the bottom of the bin with grain closer to the top, which is typically wetter, and loosen the stored grain generally, to produce a more even distribution of grain within the container, and promote faster and more efficient drying. Stirators also help to eliminate “hot spots” within the container by constantly mixing and moving grain around by rotation of the augers.

A stirator typically sits level with the top of the bin walls, at the eaves and under the roof of the storage container, so as to be at least partially within a headspace thereof. Grain storage in containers with stirators is typically level, as one cannot “peak” the grain in such a container with a stirator installed.

Stirators generally have at least one, and usually two or more, augers that hang in a vertical position down from an arm that is typically perpendicular to a bin wall. This arm rotates around the container in a manner similar to the hour hand on a clock. The augers ride on a trolley or carriage system that moves them closer to the center of the bin or toward the wall as the arm rotates. Generally, this is accomplished by a cam (a rotating or sliding element that is mechanically linked to provide oscillating or reciprocating motion to another element) system that changes the radius with respect to the degree each time around. For example, on a first pass it might be at the center of the container, when it is at the twelve o'clock position; the next time around it might be three feet out from the center when it passes the twelve o'clock position, and so forth.

Issues with existing stirators include a lack of integration into a greater in-bin drying ecosystem, automation of all of the mechanical components comprising stirators, and the down time associated with failed components. Additionally, stirators and the mechanical components that comprise them are generally not configured with sensors that collect and store data representing in-bin grain conditions to manage said grain and grain moisture content. Further, there is no integration of data from other sensors in any real-time modeling of such conditions, neither from the field nor embedded within the stored grain itself which could be used to record and report the carbon use related to the grain and drying of said grain.

In the drying of a grain crop such as corn, each bushel of corn can capture 34 lbs of CO₂ in its growing process. However, the production process of corn—including the steps of harvesting, drying, and transporting causes massive greenhouse gas (GHG) emissions, offsetting this capture. The drying of corn alone releases an estimated 2.9 lbs of CO₂ per bushel, and the drying process is a crucial production step which cannot be substituted. The tremendous amount of carbon emitted in this process is partially due to the heat required to condition the air used to dry the corn. This heat is utilized over a long duration of time, requiring a large expenditure of carbon to heat the air. This 2.9 lbs per bushel translates to 43.5 billion lbs of CO₂ emitted into the atmosphere each year in the United States from the drying process alone. As corn production grows annually, so do the GHG emissions associated with the current drying process. The U.S. Department of Agriculture estimates that in 2018, the United States emitted 698 million tons of CO₂ from agricultural production; using this estimation, drying corn represents roughly 21.7 million tons or 3% of the total CO₂ emissions of the annual agriculture output of the United States.

Carbon credits are permits that allow holders to emit a certain amount of carbon dioxide or other greenhouse gases; one credit permits the emission of a certain amount of carbon dioxide or the equivalent in other greenhouse gases. Companies are typically allotted a certain number of credits and may trade them to help balance total worldwide emissions. They can earn money by reducing their emissions and selling their excess allowances. Farmers, therefore, have a strong incentive to reduce emissions to be able to sell their credits and are in need of technological solutions that allow for reducing, tracking, and authenticating reductions in GHG emissions as well as verifying the data used to facilitate such carbon credit related transactions. Additionally, farmers could garner a premium in the market for crops produced in a low carbon manner as this low carbon production allows the processors of the crop to reduce the carbon intensity (CI) score of the end product as well as market the low carbon corn to consumers interested in such a product. In the example of corn to be used in ethanol production, a reduction in the CI of the ethanol potentially allows ethanol producers to garner premiums in the market and tax credits as well.

Carbon characteristics are one of the metrics that can contribute to the market value of a crop. The other metric that can contribute to market value is crop quality. The quality is intimately connected to the location where the crop was grown, how it was grown, and how it was dried and stored. Within each of these steps there are many factors that contribute to the carbon metrics of the crop. All of the field practices and drying and storage practices are part of the unique crop characteristics and are related to the end value of the crop in the market. All of the data that makes up the unique crop characteristics for a crop must be measured, verified, and tracked in a way that provides the buyers and sellers the data and confidence to make valuation decisions.

Two key parts of the unique crop characteristics that must be considered and are important to highlight are the field activities and the drying and storage activities. With respect to field activities, the information on fuel, chemicals, fertilizers and tillage practices must be gathered and preserved so they can be bound to the actual crop. Drying and storage are the next steps after it leaves the field and are the next steps in the supply chain. Here lies the importance of data generation and data preservation. This data must be tied to the crop in order for the carbon credits to follow the crop down the supply chain. The drying time, weather conditions, and machinery performance are a few of the factors that contribute to the unique crop characteristics. The capture of machinery performance data can provide important information about whether the crop's value has increased or decreased during its time in drying and storage. A healthy and high-performing drying and storage facility can add value to the crop, but the lack of the same could result in a crop that cannot be sold.

A secure ledger, such as a blockchain, represents a collection of data and transaction sets or contracts that operate upon the data to document and describe changes in state of one or more underlying assets. In a blockchain, all users must come to a consensus to determine the history of asset control. This provides a computationally immutable ordering of transactions involving the asset(s). A blockchain utilizes networks of computers to keep and verify records. Each computer stores a “block,” which is a chunk of time-stamped data, and linked to the next computer, where another block is stored to form a “chain.” Each of these blocks is locked, so that only those who have been granted access are allowed to view or utilize that data. Third party verification of a transaction is not necessary, as the very nature of the blockchain performs the necessary verifications on its own through a consensus algorithm. Blockchains may also be thought of as decentralized digital operating systems providing an electronic replicated ledger in which transactions, such as those involving cryptographic currencies, assets, or tokens are recorded and validated.

Blockchains can be developed to support transactions of any type. Such transactions may use tokens to uniquely identify physical or digital assets using a cryptographic one-way hash of information that establishes the provenance of each asset. Such a token can then be used in transactions of the asset stored on the blockchain, creating a full, transparent audit trail of those transactions. To enable more complex transactions, “smart contracts” have been developed; these are computer code that programmatically execute transactions that may be defined by the terms of a written contract or other pre-defined conditions governing such transactions. Smart contracts may be executed within a secure platform such as an Ethereum Virtual Machine that supports recording transactions in a distributed ledger. In addition, the smart contract itself may be recorded as a transaction in the distributed ledger using an identity token that is a hash of the computer code, so that the computer code that is executed can be authenticated. When a transaction is recorded against a smart contract, a message is sent to the smart contract, and the computer code of the smart contract executes to implement the transaction. The computer code therefore ensures that all the pre-defined conditions are met before the transaction is recorded in the blockchain.

One issue with existing approaches to data collection and its uses in the reduction of greenhouse gas emissions is that there is no currently-developed trustless, permissionless framework for tracking and verifying the authenticity of data that establishes a reduction in agricultural production. While data collection methods are common and large amounts of data are routinely collected, there is no currently-available approach to immutably validating a grower's carbon-related data that eliminates the need for trust between parties to transactions involving such data.

### BRIEF SUMMARY OF THE INVENTION

The present invention is, according to one embodiment thereof, applicable in precision agricultural situations where grains and other crops, which may be collectively referred to herein as agricultural crops, stored crops, or simply crops and sometimes referred to as grain, are stored in containers and acted upon in some form by a mechanical system having one or more auxiliary devices configured within or near the container, such as for example stirators used to agitate or mix the crop or augers and conveyors used to transport the crop. The present invention is also applicable in other embodiments, such as for example where crops stored in a container are dried using continuous flow dryers and re-conditioned at a later time, and for example where no stirators are used. Typically following a continuous flow dryer or similar, any combination of the following would take place: the final few moisture points would be removed from the grain, the grain would be stored, and the grain would be reconditioned to a storage or market moisture content. Regardless of the embodiment, sensors are utilized to collect information on both the bin systems and the stored crop.

The present invention is performed within a software framework that provides, in one characterization thereof, an “Auto-Stir” system, using one or more intelligent controllers that operate, monitor, and allow for control of stirators and the various components thereof. The software framework, and the Auto-Stir system (both of which may be provided within the context of a comprehensive post-harvest crop management platform) collects data on the grain and any auxiliary devices as the stirators move within a container, using both wireless sensors built into augers (provided that augers are present) and transient sensors that are embedded within and move with the grain as it is agitated to monitor conditions in the container, as well as performing equipment management functions such as monitoring for failure or malfunction (for example, to alert and shut off if motors overheat) as well as to adjust operational parameters in response to sensed conditions. The location of augers is tracked by the controllers and the location of the transient sensors, as well as those coupled to augers or other components, are triangulated to generate a map of the grain within the container. The fan and burner adjacent to the container (and other relevant equipment) may also be associated within the intelligent controller(s) so that they are also under automatic control, allowing the present invention to be configured to only dry grain when the conditions are ideal or within preset parameters, and/or to dry grain under particular conditions. The information collected from the sensors, and the ability to control the system, may be accessed using a support tool and/or application for remote operation and adjustment.

The present invention is therefore performed, in accordance with one embodiment of the present invention, in conjunction with an assembly comprised of a stirator and one or more augers configured within the container. Alternatively, and also in accordance with one or more other embodiments, the present invention may be performed independent of any specific hardware assembly as a stand-alone software application, and applicable to any stirring machine of any configuration or other in-bin drying, storage and reconditioning.

The present invention is also, in a further embodiment thereof, applicable in precision agriculture situations where sensors are associated with grains and other crops while they are both in-field and in-bin, regardless of whether a stirator is associated with a container to agitate or mix the grain. Such sensors are used to collect comprehensive data representing grain conditions across different time periods, and can be used as a basis for tracking greenhouse gas (GHG) emissions and reductions in such emissions and the tracking of crop characteristics that can contribute to the crops market value. In the present invention, sensor data (both data collected from in-field sensors, machinery operating in the field, visual data, data collected from auger, blade, or other stirator-based sensors, and data collected from sensors embedded within the grain and any other in-bin sensors) is stored and tracked using a secure ledger, such as a blockchain-based distributed ledger and associated computing environments. The present invention according to this embodiment therefore includes a software framework that records and stores such sensor data in a blockchain, and enables such data to be verified and authenticated in a trustless, permissionless manner for executing transactions involving such data. This includes the creation of ‘smart’ contracts, which are, as noted above, computer code that programmatically executes transactions that may be defined by the terms of a written contract or other pre-defined conditions governing such transactions and the minting of non-fungible tokens (NFTs) governed by such smart contracts which represent ownership of carbon-related grain data.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a block diagram illustrating a framework for the automated operations of bin systems in a grain storage container according to one embodiment of the present invention;

FIG. 2 is a diagram of types of data sources that are collected within an agricultural supply chain and stored on a secure ledger or database, according to another embodiment of the present invention;

FIG. 3 illustrates a flow chart of an exemplary structure of control models within a framework according to the embodiment of FIG. 1;

FIG. 4 is a flow chart of a supervisory, or self-tuning, model, within a framework according to the embodiment of FIG. 1;

FIG. 5 is a flow chart that illustrates the tracking and storing of data on a ledger and within a crop supply chain;

FIG. 6 is a flow chart that illustrates tracking and data collecting points and functions related to having transient sensors in a post-harvest crop as it moves through a supply chain;

FIG. 7 is a flow chart that illustrates tracking and data collecting points and functions related to the creation of a connected supply chain without the use of physical, wireless transient sensors; and

FIG. 8 is a flow chart of types of data that is stored in a secure ledger and tokenized in one or more non-fungible tokens according to one embodiment of the present invention.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

The present invention is a software framework that manages, in one or more systems and methods thereof, the automated operation of auxiliary bin systems and associated auxiliary devices such as, for example, stirators that are configured within crop storage containers, at least in conjunction with data collected from sensors that are both configured with such as auxiliary devices and associated with a grain mass within the containers. Such sensors associated with a grain mass may include, but are not limited to, sensors embedded within a grain crop stored in such containers or in a larger grain facility. The software framework therefore operates to control the hardware components of stirators and other bin systems which are described further herein.

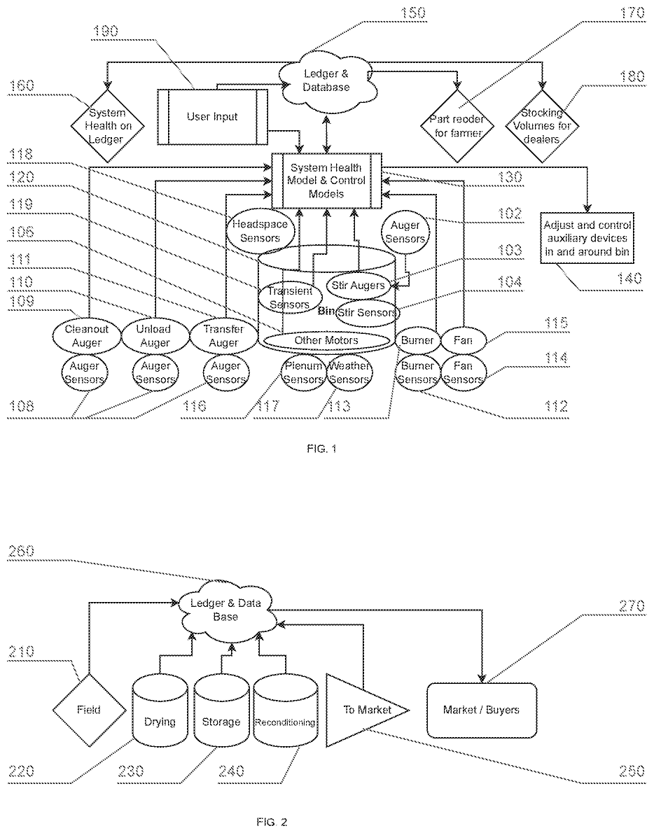

FIG. 1 is a block diagram illustrating aspects of a framework 100 for automated operation of auxiliary bin systems and associated auxiliary devices, as well as follow-on uses of one or more outputs of such a framework 100. FIG. 1 illustrates that the framework 100 ingests, receives, requests, or otherwise obtains input data that includes many types of information relative to a stored grain mass, the auxiliary devices of a bin system, and the crop storage container itself and conditions therein. Analysis of this input data in the framework 100 enables the creation of a system health profile that forms an output dataset that represents one or more system health metrics for the bin system, as well as characteristics of the grain mass and the container. Data elements of this system health profile are stored in a secure ledger and database environment 150, as discussed further herein, for follow-on applications and uses.

It is to be noted that the framework 100 of the present invention is embodied within one or more systems and/or methods that are performed in a plurality of data processing elements that are components within a broader computing environment. The computing environment also includes one or more processors and a plurality of software and hardware components. One or more processors and a plurality of software and hardware components are configured to execute program instructions or routines to perform the modules, components, and data processing functions described herein, and embodied within the plurality of data processing elements.

FIG. 1 illustrates that input data is collected from many different types of sensors. As noted above, these sensors provide information relative to a stored grain mass, the auxiliary devices of a bin system, and the crop storage container 120 itself and the conditions therein. For example, sensors that provide information relative to a bin system and associated auxiliary devices include auger sensors 102 associated with stir augers 103, stir sensors 104, and sensors coupled to other motors 106. Other sensors coupled to additional auxiliary devices include auger sensors 108 that are coupled to cleanout augers 109, unloading augers 110, and transfer augers 111. Still further, sensors associated with other auxiliary devices include burner sensors 112 associated with a burner(s) 113, and fan sensors 114 associated with fan(s) 115. Input data may be further provided by sensors associated with a grain storage container itself, such as plenum sensors 116, weather sensors 117, and headspace sensors 118. Sensors may also be associated with the stored grain mass, such as transient sensors 119.

Other types of sensors, and the data they collect, are described further herein. Regardless, it is to be understood that the framework 100 of the present invention may analyze data from sources across a broader supply chain for a grain crop. FIG. 2 is a diagram illustrating types of data sources that are collected with such a supply chain; input data is collected regarding the field 210, drying 220, storage 230, reconditioning 240, and sources relative to providing and delivering the grain crop to a market 250. All of these sources of data are written and stored in a ledger and database environment 260, and may be used in a variety of ways, such as, for example, for characterizing the crop and delivering insight to a market and buyers 270.

Returning to FIG. 1, the sensors illustrated collect input data that is provided to a system health model 130. The system health model 130 is a collection of data processing elements that perform data analytics on the input data, such as for example machine learning-based control models that analyze moisture content and drying rate; the outputs of such models are used to monitor and control bin systems, and generate useful crop-related outputs that represent characteristics of the stored grain and the container, such as those comprising a carbon intensity score. Regardless, these machine learning-based models are comprised of algorithms that generally include one or both of neural networks and dynamic process equations and represent applications of artificial intelligence and machine learning to the various models described herein.

Still further, these machine learning-based models include different types of models are described further herein. The framework 100 of the present invention contemplates that machine learning-based models that represent virtual sensors may be developed and applied to generate the types of outputs described above.

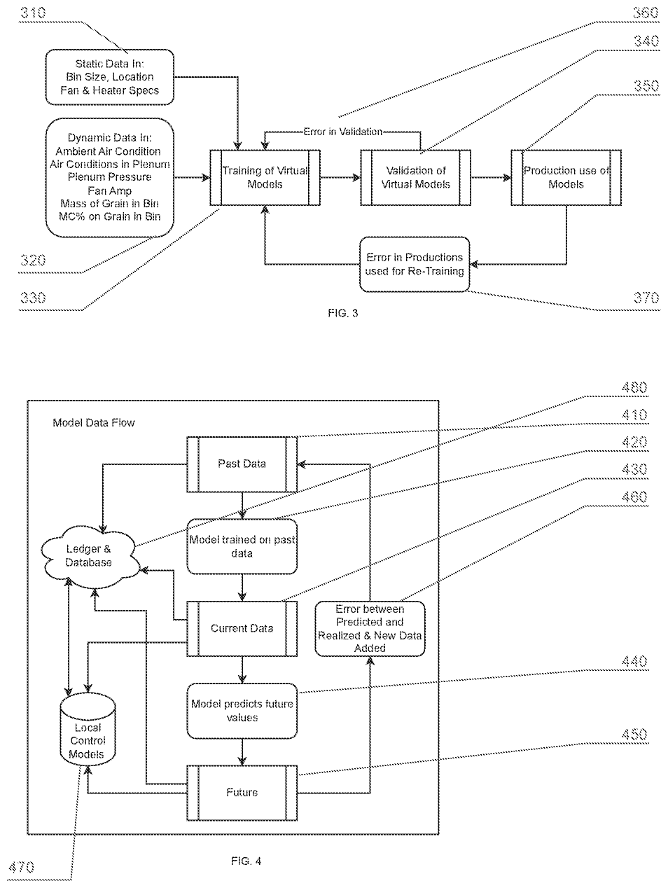

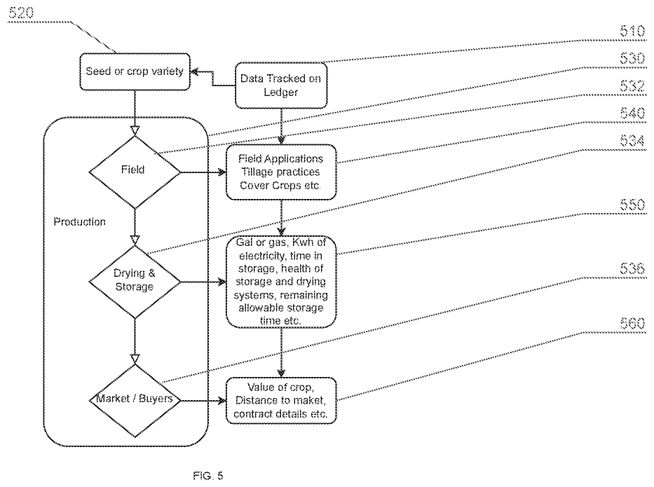

FIG. 3 and FIG. 4 are flow charts that illustrate how virtual machine learning-based models are developed and applied within the framework 100. FIG. 3 illustrates a flow chart of an exemplary structure of control models, and FIG. 4 is a flow chart of a supervisory or self-tuning model.

In FIG. 3, inputs are comprised of static data 310, and dynamic data 320. Static data 310 is information that includes information such as bin size, bin location, and fan and heater specifications. Dynamic data 320 is information that includes ambient air condition, air condition in the plenum, plenum pressure, fan amperage, mass of the grain stored in the container, and moisture content of the grain stored in the container. As noted below, virtual control models for monitoring and controlling bin systems include three types of models—training 330 of virtual models, validation 340 of virtual models, and production 350 of virtual models. Each of the validation 340 and production 350 steps of developing a virtual machine learning-based control model in the system health model 130 include feedback steps. An error loop 360 corrects errors in the testing of training models 330, and an error loop 370 corrects errors when the testing or validation model is applied in production by measuring the estimated output at a future time against the realized output at the actual time.

FIG. 4 illustrates how these virtual models generally incorporate error correction for continuous self-tuning. Past or historical data 410 is obtained, and models are trained 420 on this past or historical data 410. Current or newer data 430 is then obtained and the trained model is applied to predict future values 440 based on the current or newer data 430. At a future time 450, the performance of the model is tested by measuring the error 460 between predicted and realized performance. New data is also added, and the model is continuously retrained.

A local control model 470 in FIG. 4 allows the framework 100 to use current and future estimation information from the virtual sensors generated from the machine learning-based models in the process control loops running locally at the container. This architecture allows the models to be used on the “edge” (running in local computational devices) and operate with or without internet connectivity. Information generated by the self-tuning or supervisory model of FIG. 4 is stored and maintained in a ledger or database 480.

The framework 100 also integrates one or more user inputs 190. A user input 190 is enabled through a local or remote interface, through which an operator can observe the operation and performance of a bin system, provide further information to the framework 100 as input data, and change, adjust, or modify settings. An example of a user input 190 may be a user turning on or off bin systems from a local human-machine interface, website, or mobile phone application. Another example may be an interaction where a user enters authentication codes to execute a smart contract to fill a transport container with a contract crop. This user may be a human, a machine, or another smart contract, submitting the codes manually or digitally over a wireless link.

Outputs of the system health model 130 include one or more datasets representing a system health profile, which is a collection of data points that represent some output of the system health model 130. One or more elements of such a dataset may be applied to perform various follow-on applications and functions, such as for example controlling and adjusting bin systems 140. Outputs are also written and stored to ledger and database 150, and used to perform additional functions such as reporting system health 160, automating (or informing management personnel of a need for) ordering bin system parts 170, and providing dealers with stocking volumes 180. The framework 100 may be utilized, for example, to provide notice of an anticipated volume of a part, such as a number of fans, which a dealer of such fans can then order from a manufacturer. Because such orders require lead time, if a dealer is able to provide an order for the correct number of fans prior to needing the fans, the manufacturer can produce the fans in time and reduce delays associated with part replacement. In a further example of an output of the framework 100, information such as that a particular fan model overdraws amperage after 3600 hours of operation or after 24 start-stop cycles, is useful for a manufacturer to know, for future product design.

One type of mechanical bin system that is controlled by the framework 100 of the present invention is a stirator. A stirator is an auxiliary device that generally comprises an arm that is positioned level with a top of container walls, and above the top level of stored grain, under the roof of the container and within its headspace. The stirator also has one or more augers that extend vertically and down from the arm. The arm rotates around the bin, along either a track that extends around the inside of the container, or using another rotational system such as for example rotating about a central element that extends from the container roof (or both). The augers typically ride along a carriage-type system that moves them either closer to the center of the bin or toward the wall as the arm rotates around and within the container. The augers rotate to agitate and mix the grain by continuously moving drier grain, typically from the bottom of the container to the top, where wetter grain is typically found. The stirator also includes a system of motors for operating the various mechanical components thereof. This system of motors may include one or more auger motors, one or more carriage motors, and one or more motors for rotating the arm around and within the container.

Stirators, as noted above, are one type of bin system that may be utilized within, around, or adjacent to a container. In addition to monitoring, controlling, and adjusting operation of a stirator, it is to be understood that the framework 100 may also monitor, control and adjust additional hardware components in auxiliary devices that are configured within, around or adjacent to the container. These types of auxiliary devices may include, but are not limited to, one or more transfer augers, a cleanout auger, an unload auger, a fan, a burner, a vapor solenoid that controls a flow rate of propane into the burner, and devices controlling the source of the propane (or other fuel) supplying the burner. Still other types of auxiliary devices include elevators, platforms, conveyors (such as pneumatic, slat, belt, or bucket conveyors for transferring grain), bagging systems, aeration systems, drainage systems, fumigation systems, security systems, cameras, doors, gates, and other mechanical systems, devices, and machines. It is therefore to be understood that the framework 100 is applicable to many types of bin systems for monitoring, controlling, and adjusting auxiliary devices associated with a grain storage container, and therefore neither the present invention, nor this specification or the claims, are to be limited to any specific type of bin system or auxiliary device specifically referenced herein.

A stirator (along with other bin systems) is outfitted with (and/or configured to operate in conjunction with) a plurality of sensors. These include wireless sensors such as relative humidity, temperature, and carbon dioxide (CO₂) sensors that are coupled to the tips of at least one, and generally more than one, of the augers on each stirator. Such sensors may also be coupled to the stirator arm. Regardless, these relative humidity, temperature, and CO₂ sensors map the conditions of the grain at the end of or in close proximity to the augers, and as the augers traverse through the grain. These sensors are wireless to eliminate the mechanical damage done to the infrastructure of the container due to the nature of a stirator, which powerfully, brutally, and mechanically forces its way through the grain and has the potential to cause failure in any structure that a cable is attached to. Use of wireless sensors on the augers also provides the ability to map the physical location of each sensor as the stirator moves through the grain, for example using trilateration, by knowing the relative distance between any two (or more) sensors and the receiver. This helps the stirator be more efficient, by providing information that may be used to locate the augers to a desirable location that was previously mapped and measured inside the container.

It is to be understood that such sensors may be placed anywhere on such augers coupled to a stirator. Placing wireless relative humidity, temperature, and CO₂ sensors at the middle and top sections of the augers allows for an understanding of which grain needs to be inverted using the stirator, at which level(s) of the grain within the container, and also for more precisely locating where the stirator should be directed in response to sensed conditions in the stored grain.

In addition to sensors coupled to a stirator or other mechanical bin system, wireless sensors that detect relative humidity, temperature, and CO₂ may also be floating in the grain mass within the container, and the framework 100 of the present invention is therefore also able to obtain data from transient sensors 119 that are not directly coupled to any hardware components of a stirator. Such transient sensors 119 may be sensors that are associated with the stored crop at multiple stages in the supply chain of such a crop, such as for example sensors affixed to the crop when it was planted and/or during the growing season; in other words, throughout the in-field and post-field life cycle of the crop. These transient sensors 119 float in the grain mass while it is stored in the container, and further allow for an understanding of which section or portion of the stored grain needs to be inverted, and for direction and placement of the stirator to provide another layer of efficiency by allowing the intelligent controller to direct the stirator to where it needs to go. Such ‘floating’ wireless sensors capturing relative humidity, temperature, and CO₂ measurements are generally not to be excluded from mapping of the grain mass, but may be excluded where necessary to prevent inaccurate data from too many of them rising to the surface of the grain and producing unhelpful measurements, and thus eliminating or diminishing the usefulness they provide by being embedded in the grain mass.

Other sensors may also be coupled to auxiliary devices comprising bin systems. For example, sensors may be included to prevent a stirator from starting if the grain is filled too high. Such sensors may include at least one of the proximity sensor(s) on or near the augers, sonar (or other range finding) sensor(s) on the auger carriage system, and a camera (or cameras) that captures and feeds images to a processor for modeling using algorithms that comprise models trained with machine learning. Also, to prevent ruining stirator motors if the grain is filled too high, and to monitor health, an amperage meter/sensor may also be included on one or more of the rotating arm motor(s), the carriage motor(s), and the auger motor(s).

The framework 100 is therefore configured to model the various types of sensor data to perform multiple functions of the stirator. The framework 100 is also configured to model various characteristics of the grain itself from sensor data, as noted above, and is able to control, modify, and adjust stirator operation based on the modeling of both sensor data generally, and modeling of the various grain characteristics.

The framework 100 includes multiple algorithms for these purposes, and applies those algorithms in the system health model 130. These algorithms generally include one or both of neural networks and dynamic process equations, and represent applications of artificial intelligence and machine learning to the various models described herein. These algorithms take, as input data, information collected from the plurality of sensors to determine operational characteristics of bin systems such as a stirator, and determine characteristics of the grain mass, to produce the various outputs described, such as useful crop-related outputs representing a carbon intensity score, monitoring and control of bin systems, and outputs representing characteristics of the stored grain and the container. In one exemplary manner of applying the system health model 130, the algorithms developed in the framework 100 can utilize first and second-order dynamic modeling equations and other phenomenological system equations as a dynamic block in a multi-layer block-oriented model structure. Using these dynamic equations requires using a backward difference derivative estimation to transform the equations from continuous time into discrete time. Discrete-time estimation is important in allowing these models to be used in a machine-learning model architecture. Another model structure used in this machine-learning architecture is one or more neural networks that are added as static blocks. These model structures are combined to create a hybrid model with linear and non-linear dynamics provided through semi-theoretical equations using physically interpretable parameters and empirical equations with unobservable parameters. This hybrid model creates the machine learning architecture to which machine learning techniques are applied to train and validate the models ensuring the solution reaches a global minimum to provide robust model performance.

There are many examples of how the system health model 130 may be utilized within the framework 100 for control, modification, and adjustment of bin system operation such as stirator operation. For example, auger speed may be adjusted to speed up or slow down drying of the grain, and auger positioning along the carriage system and within the grain may be adjusted to target areas of the grain which need attention (for example, to mitigate a “hot spot”). The rotational arm speed of the stirator may similarly be adjusted using the algorithms of the framework 100.

The framework 100 may also include one or more algorithms that model and determine stirator health and maintenance. For example, a time-on tracker may determine run-time of each part, not unlike a vehicle's odometer with recommended maintenance that may be set on a schedule, with either standard lead times or alerts at a certain amount of time prior to harvest, depending on the crop. A management support tool of the framework 100 may enable users to input and set parameters, for example for when parts have been replaced to reset such a time-on tracker.

In addition to determining moisture content of the crop from transient sensors 119, the framework 100 of the present invention may also include algorithms that determine the moisture content or drying rate of the crop stored in the container using sensors that are positioned outside of the crop itself. For example, the framework 100 may use the temperature and humidity readings at one or both of the fan and in the headspace of the container, to create a virtual sensor of the moisture content or drying rate of the crop. These models representing virtual sensors may be generated using machine learning algorithms in neural network models which are trained on the data from a multitude of systems to produce a virtual sensor for moisture content. The framework 100 may also have the capability to allow these models to run in a cloud computing environment, where larger computational power is available. The models running in such a cloud computing environment are referred to as virtual models, and may be fed by data coming from a bin system deployed in the field in real time. The virtual models may also have the ability and the computational power necessary to perform self-learning functions to improve the accuracy of the virtual sensors. When an improved model is generated by the virtual model, the parameters may then be sent to the bin system in the field.

The framework 100 may also include algorithms that use the virtual sensors for things like moisture content or drying rate as part of controller loops. The virtual sensor output may be used as input for a feedback control loop to provide the system health model 130 with information about when the desired moisture content has been reached, or when the drying rate is occurring in a satisfactory manner. This feedback control function allows the system health model 130 to, for example, estimate when drying is completed without a requirement to have sensors in the grain mass. If sensors are in the grain mass, the virtual moisture content sensor may be part of a feed forward control loop. A strong virtual sensor model allows the system to predict the moisture content hours or days into the future. The future moisture content may then be used to make control decisions in the current time to improve the effectiveness of the operation of the bin system and/or the container itself. For example, changes in the ambient temperature and humidity reading at the fan when used by a model trained to predict six hours is able to identify the weather patterns indicative of an increase in humidity, i.e. rain. This allows the controller to make changes to the current time that improve performance with respect to an increase in humidity in the next six hours. Another example is a virtual sensor specifically for drying rate which is trained to predict the rate at which the crop will dry a day in the future. This allows the controller function of the framework 100 to optimize itself in the current time to maintain optimal performance to reach the desired state by a desired time.

Returning to FIG. 3 and FIG. 4, and as noted above, the framework 100 of the present invention utilizes multiple models to aggregate the various types of input data into useful outputs, such as generating control information, and providing alerts about process and system health. These models may be generalized into three types. The first type of model is a data aggregation model, which processes many different inputs and produces a useful, customizable output such as for example carbon metrics or allowable storage time. The second is a control model, which processes data from particular types of inputs and provides information to a controller to improve performance of bin systems or the container itself. The third type of model includes supervising models. Each of these models is developed in different ways.

The data aggregation model is developed using mathematical models that are built upon to provide a full picture of the data for the characteristics desired by, or interest to, the user. For carbon metrics, a model such as GREET may be used as the base model; this model takes electrical, fuel, and mileage data to create a concise carbon intensity (CI) score for the crop. This CI-focused model may be enhanced by adding, for example, cover crop carbon metrics to the existing GREET model to provide a more holistic model for crop production. Many other types of carbon-relative data metrics are possible and may be added to such a model, such as for example crop type, planting time, soil organic matter levels, previous crop, tillage practice, cover crop usage, watering practices, fertilizer practices, and other data of significance in an agricultural environment.

In the development process for control models in the framework 100, inputs from a specific system are first used to train the model on historical data. The model is trained to estimate some desired manipulated variable (MV) using data from other variables. Training is done using different model structures, which may include neural networks, other dynamic equations, or a combination of these to create the machine learning architecture of the model. Machine learning optimization algorithms may also be applied to these structures to tune the parameters in the model to allow for the estimation of the manipulated variable in a robust fashion. This optimization is performed by summing the error of the model's estimated output compared to the measured output. During validation the new model is given a new set of data and the performance of the model is tested. The error between the measured output and estimated output is again summed up to determine the model's performance. The present invention adds another step in this process, which is a production layer of model development. The production layer of model development is performed continuously while the model is being used. Production development may occur when the model is being used for forecasting. That means the model is estimating the output some time in the future and then as that time step occurs the error between the forecasted and realized output may be used to further optimize the model. The production development may also occur outside of the control operation and may be performed on another computational unit, such as within a cloud computing environment, at a set cadence. For example, a model for moisture content in a container is trained and validated on historical data, and this model is then deployed to a container to provide a future prediction of the moisture content in that container. While the model is running for the container, the errors of future prediction and the realized output are stored and at some cadence, this error and the new data generated are sent to the cloud. In the cloud, the model is re-trained using the error and the new data. The updated parameters are then sent back down to the container to be used in the model moving forward. This allows the model to continually improve and adapt to changing real world conditions.

In the supervisory model, input data from a system or systems is used to train a model to either trigger or predict an event that is about to or will occur. A trigger supervision model uses inputs like visual (i.e. captured by a camera) and sensor data to watch an auger arm move around a bin; when the arm stops the model may trigger an alert. The model structures in these supervisory models may include specific machine and dynamic equations for modeling the other types of inputs. These models can be trained by creating the event that should trigger the alert and then training the model to produce an alert under those conditions. In validation, the model is given data from a known trigger event, and it is tested to confirm the alert is generated when the event occurred.

Training and testing of a prediction supervision model are similar to that of a trigger supervision model; one difference, however, is that such a model should produce an alert about an event before the event occurs. For example, the framework 100 may be designed to generate an alert of a fan motor failure a week before the event occurs. To develop this prediction supervision model, the training is performed in a way that forces the use of week-old data in the historical data set to generate a current-time alert. This is required as, when used in production, the data that is seen right before the event has not occurred yet, meaning it can only use current time data to predict a week into the future. In addition, the same future versus realized error data can be used to improve the model over time. If the model does not predict a fan failure a week from now but one does occur, the model sends this error and new data to the cloud to have the model re-trained to provide an improved prediction in the future. The framework 100 includes the ability to enable each storage container in a network of containers to “talk” to each other (by sending and receiving data back and forth between one another), or to a central database, and the framework 100 may include one or more algorithms that determine how long stirator parts take to wear out, by taking into account different geographies, crop types, weather conditions, bin sizes, stirator motor sizes, stirator health, improvement of models for virtual sensors and other characteristics of both crops and mechanical equipment or hardware. Another embodiment of this framework 100 enables all of the aforementioned monitoring of the health or remaining motor life of conveyance equipment including but not limited to equipment in the bin system such as fans and heaters, augers transporting grain to a bin, augers cleaning out the final amount of grain in a bin that cannot flow due to gravity, augers pulling grain out of a bin, and augers transporting grain away from a bin.

The framework 100 may also include algorithms that determine how long a crop takes to dry, also taking into account different geographies, crop types, growing practices, weather conditions, bin sizes, stirator motor sizes, stirator health, and other characteristics such as fan types, fan sizes, burner types, and burner sizes. Still further, the framework 100 may include algorithms that determine a relative value of the stored grain, using the sensor data collected from within the grain itself which may include sensors coupled to the stirator.

The framework 100 may also include algorithms that provide feedback as input data on grain quality and/or grain value, so that changes can be made dynamically between and during batches in response to variations in the performance of the bin system. In other words, data collected during a drying campaign can be used to adjust crop properties between and during batches to optimize system performance in value or economic terms. Similarly, the framework 100 may include algorithms that model minute, step-wise changes in system operation so as to induce changes that could be put into place over the broader context of all affiliated systems, and also that let the system adapt from one another. For example, the framework 100 may run algorithms that allow the system to stray by 10% in both directions to gather information and improve the set points. Therefore, it is to be understood that the algorithms executed by the framework 100 may include one or more machine learning algorithms that enable the stirator system (and, possibly, affiliated systems) to learn and improve. These may include, by way of example, neural networks and other similar techniques, as well as other methods of artificial intelligence, such as statistical and regression analyses.

The framework 100 may include one or more centralized or decentralized database collections that together comprise and will be referred to herein as a “database” generally, and such a database may be used to perform different functions. For example, the data in such a database may be used to determine either mechanical or drying-related behavioral changes to correct faults, together with the algorithms and modeling performed within the framework 100. For example, the present invention may dynamically adjust timing (or, change the rate) of rotation of the stirator based on the moisture content; the dryer it is, the quicker the stirator can move through it since it provides less resistance and wear and tear on the machinery. This could also be considered a drying-related behavior, because one might want to ensure that more drying gets done while the grain is wet (and therefore has a higher drying rate compared to dryer corn), then mix it in and allow diffusion to even out the moisture content of the grain mass as a whole.

Each container in a network of such containers may be able to “talk” to a database (by sending and receiving data to and from the database), which may invoke algorithms that are able to perform functions such as identifying faulty or otherwise design-flawed equipment or equipment that could be improved, coupled with exact use cases or broad generalized use categories. This may include sending information to the company that sends parts out to dealers and end-users so that they can make better design and engineering decisions. The present invention may also be able, in a further use case, to preemptively send out alerts for replacement parts equal to the lead time so that they arrive just in time for replacement.

The plurality of sensors may also include other sensors not directly coupled to, or operating in conjunction with, the stirator. These may include a pressure sensor for monitoring the propane supply. Such a pressure sensor monitors how much gas is in a propane tank, and allows for the ordering of more propane in a just-in-time approach, rather than guessing or ordering on a regular basis, without knowing how much is remaining and how much is needed. It also allows for rationing remaining propane until more is obtained. Such a sensor therefore assists in determining both a total cost of goods, as well as obtaining a more accurate picture of the “carbon footprint” involved in drying a crop in a container. The propane supply pressure sensor may also be used for geographically determining drying ‘recipes’, and may be used as a redundant check to determine if the burner is on. This sensor may also provide feedback for the control of the vapor solenoid.

Another pressure sensor, a line pressure sensor, may also be included and configured after the vapor solenoid and before the burner, to monitor flow rate (or lack thereof) of gas into the burner. This sensor may also be used as a redundant check to tell if the burner is on, and also help provide feedback for the control of the vapor solenoid.

The plurality of sensors may include amperage and vibration sensors for the fans, which sense characteristics such as power to fan, and monitor fan health. Such sensors may be configured with circuitry to control operation of the fan as well. Amperage sensors for burners (that heat the stored grain) may also be included; such sensors determine characteristics such as power to burner, and flame status, as well as monitoring burner health. As with fan sensors, these sensors may be configured with circuitry to control operation of the burners. Other amperage sensors may include sensors that monitor amperage of central processing units (CPUs), graphics processing units (GPUs), or other processors. Amperage sensors may also be coupled with amperage transfer equipment and associated controllers to confirm the existence of grain in the bin. In another embodiment, more precise means of grain transfer measurements may be used, such as a mass flow device measuring flow of grain entering or leaving the bin, or both. Still further, the plurality of sensors may include plenum pressure sensors, visual sensors (such as cameras), which determine the existence and/or depth of grain, and determine and confirm airflow through the plenum.

The plurality of sensors also include sensors that monitor relative humidity, temperature, visual (image or video) data, and carbon dioxide (CO₂). Such sensors may be used, for example, to confirm grain quality in a container, and may be configured in many places, such as for example at the outside of a storage container, in the headspace, in the plenum, and in the grain itself, as well as with hardware comprising a stirator. Where configured at the outside of the storage container, characteristics such as relative humidity, temperature, and CO₂ are used to determine conditions of the air to be used or conditioned prior to conditioning. Measurements of relative humidity, temperature, and CO₂ may also be used for determining efficiency of a drying operation, for establishing reductions in GHG emissions as noted in further detail below, and for rationing remaining propane.

Other relative humidity, temperature, and CO₂ sensor(s) may be configured in the plenum to determine initial conditions of air to be used in drying the grain. In conjunction with outside air sensors, these plenum sensors may be used to provide feedback to the heater(s) (e.g. too much heat dumped into the system could damage grain by the heat, or could have too much ‘drying potential’ and cause over-drying). Such sensors may also be used as a redundancy for turning fans on and off.

Still other relative humidity, temperature, and CO₂ sensors may be placed in the headspace and plenum of the storage container, to determine initial and final conditions of air used (for example, final minus initial equals removal). Readings from such sensors also help provide feedback for the control of the burner.

The framework 100 may include, as noted above, in-field data which allows for information on activities such as use of fertilizer and cover crops for carbon sequestration to be tracked on a per-acre basis and connected to bushel data. Cover crops can help reduce greenhouse gas emissions; knowledge of planting activities, using data collected from in-field sensors, therefore improves the ability of the grower to establish reductions in GHG emissions. Combining data sets (such as, sensor data collected from both static (or tethered) and transient sensors) enables the grower to provide very detailed carbon sequestration and GHG emissions numbers for each bushel of grain that is being sold, which in turn can increase the value of each bushel as the farmer will be able to prove low environmental footprints.

In-field data may include data such as soil characteristics, and may represent different growing conditions. For example, in-field data may reflect that a field has been used to plant and grow winter wheat as a cover crop in a carbon sequestration strategy, where the soil remains active throughout a winter season, at least because the roots and shoots of the cover crop feed bacteria, fungi, earthworms and other soil organisms; such information may be relevant to drying conditions of later-planted crops, and may be modeled within the framework 100.

Regardless of what data they collect, in-field sensors are transient sensors that move with the grain or crop from the field to the storage container, and then on to a co-op or other post-drying entity and they can be added and removed during this process depending on the capabilities of the facilities and the use case of the crop. If the sensors do not physically move with the crop, the data they generate effectively moves with the crop. Such transient sensors can represent a serial number for each bushel and a security device that prevents tampering. Transient sensors may or may not have memory capabilities, depending on the application; they may be, for example, radio frequency identification (RFID) tags that are passive (with no memory capability), or active (having memory capability). Such sensors are wireless sensors that send their unique ID and readings to a receiver, which relays them to a main controller operative to control in-container conditions. The wireless sensors may be mounted to a metal cable to keep them in place as the container fills and empties. These wireless sensors may include unique features that allow them to be used as transient sensors. For example, they may have as noted above some memory capacity, unique ID numbers, long battery life, and adaptable housings for different uses and for different types of grain. Where the sensors have memory capability, this allows the sensors not to lose data even when it is not in the range of a receiver, and create a sensor log of the life of the grain. The unique ID allows each sensor to be connected to bushels stored, for example, on the blockchain-based ledger described herein. The battery life and form factor allow the sensors to survive and operate for extended periods of time in the grain mass. These sensors are either already situated in the grain as it comes in from the field, or added during the transit process, and removed during post-drying processing, for example using grates in the unloading equipment typically used to remove other foreign materials from the grain. The sensors are configured to sense when this happens due to the data they continuously collect. The sensors include cameras situated on and around the grain conveyance equipment which provide images which can be analyzed by the software to track the grain and monitor auxiliary devices and bin systems.

The data processing elements of the framework 100 include a data collection element that is gathering data from the wireless sensors or RFID tags in the grain. These data collection units may be internet-connected computers that use transmission and receiving units that are able to read the IDs of the sensors or tags as they move through the supply chain. These tracking units may be placed at points in the supply chain, such as for example load and unload docks for sites, overpasses of rail lines, and other transfer points in the supply chain. This allows the sensors and tags to be pinged as they are in the crop and provide a date, location, and current readings of temperature, humidity, and others as they move through the supply chain. The current reading or short data give snapshots along the way, and if a memory unit is present in the sensors, the full log may be downloaded after sensor recovery. The tracking units provide a near real-time stream of data taken to track crops. The larger the network of tracking units that are deployed on a site or across a geopolitical area, the more detailed the tracking becomes. An added advantage of having tracking units in the supply chain is the frequency of sensor or tag placement can be set for some lot of grain, and if this frequency is not found to be true, this may indicate the crop has been mixed, if not the same. An example of this is if a sensor or tag is placed every 1000 bushels of corn at the harvester, and this is preserved in the secure ledger token for this lot of corn, but when the corn is delivered to the final user and the sensors and tag are read or removed, and the frequency is found to be one sensor or tag per 2000 bushel then the buyer knows that mixing occurred at some step in the supply chain and the corn is not what was bought. This allows the buyer to reject a shipment of adulterated corn before unloading it.

The data processing elements of the framework 100 include a data collection element embodied in one or more algorithms configured to ingest, receive, request, or otherwise obtain input data, which includes, as suggested herein many types of information relative to a stored crop to be analyzed. This input data may include crop-related or product-related data that defines the crop, sensor data from many types of sensors as noted herein, container-specific data such as container characteristics, climate and meteorological data, and other information either provided as user inputs, collected by various sensors or other Internet-of-Things (IoT) devices (for example, data collected from devices installed on board harvesting or other farm equipment or machinery), in-field data, or provided by additional third parties or obtained from additional data sources. Each of these sources includes different types of information and is used in the stirator system to analyze the crop within the container, model various characteristics of both the grain and hardware such as a stirator configured inside a container, and actuate components of such a stirator to affect conditions within the stored grain.

User inputs may include information such as anticipated crop removal or sell dates defining a temporal limit on the storage of the crop, and parameters representing desired crop characteristic levels, such as one or more moisture content set points. These may include initial moisture content, value or anticipated starting value, crop characteristic levels, a storage moisture content value comprising a less perishable crop characteristic level, and a market moisture content value comprising a crop characteristic level fit for sale. User inputs may also include information such as the amount and type of the crop harvested, the dates of planting and harvest, and the location of the planted crop, etc. Regardless of the type of information contained therein, user inputs may be generated by the user, for example, using a decision support tool, or may be determined automatically from one or more of the other inputs provided to the system health model 130 within the framework 100.

Crop data includes many types of information defining the crop, and may include similar information such as user inputs. Such information may be both historical in nature (for prior growing seasons or off-seasons) or current in nature (for current growing seasons or off-seasons). Such information may include crop type, planting information, and harvest information. It may further include the location of the crop, such for example, geo-positional coordinates of a field or management zone in which the crop was grown, and any other information that identifies a specific field or management zone and any relevant characteristics of such a location. Still, further, the crop data may include information such as a seed type or varietal, including a seed year, as well as any treatments or nutrients applied to the crop or soil before, during, or after the growing season, and soil characteristics for the soil in which the crop was planted. Treatments and nutrients may include any organic or non-organic products, either naturally occurring or synthetic, that have an impact on ecology, biomass, plants, crops, soils, or fields. Crop data may also include information about off-season crops grown in the same or similar fields and other farm and field management information, regardless of any temporal element to such information, such as for example crop rotation information, tillage activities, irrigation information, and nutrient levels.

Many different types of sensors may be utilized to collect and provide sensor data in the present invention, and these sensors may as noted above be placed at many different places throughout a container, either within, proximate to, or separate from the crop stored therein. Sensors may include, in addition to the amperage, pressure, relative humidity, temperature, and CO₂ sensors discussed above, infrared sensors, sonar/ranging sensors, weather sensors (measuring ambient conditions in, around, or adjacent to grain storage containers, such as relative humidity, temperature, and CO₂) cameras (capturing still images or video or both), and any other sensors that can be utilized to discern conditions within either a crop or a container, or coupled to otherwise affiliated with a stirator.

Input data may also include other information such as data collected from sensors or other devices, whether affixed or coupled to particular objects or positioned in or near particular areas, in an Internet-of-Things environment (or other similar paradigms or approaches having similar names, such as the Internet-of-Farms, Internet-of-Plants, Internet-of-Crops, and Internet-of-Fields, etc.). For example, sensors coupled to agricultural vehicles may collect crop-related and field-related data relative to the conditions of a crop as it is being harvested or transported and transmit that information for collection and processing, which may be ingested into the framework 100 as input data. Other examples include soil sensors, Bluetooth™ components, LoRA components, and other devices which are able to acquire localized information that may be relevant to assessing conditions of a harvested (or about to be harvested) crop. Input data may also include data collected from crowdsourcing observations, ground truth data, and other user- or individual-generated information, for example using dedicated applications on smart or mobile computing devices.

Still other types of input data are possible and within the scope of the present invention. These may include image data, such as that collected by satellite systems, photography or video captured by remotely-piloted vehicles, commonly referred to as drones, or field-based robots configured to generate field-level images, such as those using in-field sensors. Manned and unmanned aerial reconnaissance craft may also be used to acquire image data for processing within the framework 100 of the present invention. Image data may be processed and utilized, for example, to discern and assess field utilization, and crop and plant growth, health, and any changes thereto over time, that later impact harvesting of the crop.

### Tracking of Carbon Emissions Using Sensor Data

The present invention is also, in a further embodiment thereof, a framework that tracks and verifies carbon emission-related data representing reductions in greenhouse gas (GHG) emissions identified from sensor data, at least as a result of the application of bin systems, and other systems and technologies which help to reduce carbon emissions in the storage and drying of grain crops. The framework according to this embodiment of the present invention models, records and stores data collected from sensors in a blockchain-based or similar computing environment, and enables such data to be verified and authenticated in a trustless, permissionless manner for executing transactions involving such data. The framework is also configured to create ‘smart’ contracts governing transactions involving carbon-related data (and any other relevant data) as well as the minting of non-fungible tokens (NFTs) representing ownership and tracking of carbon emission-related data.

The implementation of a secure blockchain-based ledger within the present invention secures the unique properties of the carbon emission-related data, and any other data, in a cryptographic format. Such an implementation enables the present invention to become a data source that is secure and easily usable by other similarly-configured software applications that interact with the carbon emission-related data, regardless of whether such applications are on-chain or off-chain. For example, a key metric to be secured in this manner is the net CO₂ in each bushel, and the present invention contemplates that this data can be accessed and utilized in one or more decentralized applications. The related CO₂ and other data can also be transferred from the farmer to a buyer based on information recorded in a ledger or similar technology, regardless of whether ownership of such carbon emission-related data is tokenized. Unique numbers related to a transient wireless sensor can also be integrated into the ledger to fully secure the grain and the ledger, providing further opportunity for authentication of data supporting transactions, and further verification of the underlying carbon emission-related data. For example, wireless sensors may act to verify the presence of and measure the conditions of grain until it is moved through a removal screen before or after the unload auger. Wireless sensors have an internal memory that sense and log sensors capturing data such as temperature, humidity, GPS location, acceleration, gyroscopic movements and CO₂. This internal data may then be recovered during use or after the removal of the sensor from the grain to create a complete picture of the grain's life. This data may then be added to the ledger and become a factor in the value of the grain in a transaction once it leaves the bin system.

The present invention contemplates that smart contracts can be developed that enable farmers to monetize carbon emission-related data collected and modeled. The framework is configured to run such smart contracts within secure blockchain-based protocols, integrate smart contracts with other agricultural software systems (either grower-side proprietary systems such as drying management software, or other merchant agricultural systems) at least to confirm actions therein, and develop transaction capabilities based on such smart contracts that allow data representing, for example, GHG emissions of a bushel of grain to be moved from owner to buyer. In addition, the use of smart contracts allows for the automation of contract fulfillment. For example, when a sale is made a smart contract may be created with a signature code or verification method. Then this code is input at the bin manually through a user input device, or digitally transmitted, and the bin can then “unlock” and transfer the contracted amount of the crop to the transport container by activating the transfer auger in the bin system. Without the correct code the bin will stay “locked”. This functionality allows for autonomous transport machines to arrive at bins, transmit the verification code, and be automatically filled with the contracted amount of crop using the smart contract framework. Internet connectivity combined with the “locking” and “unlocking” of bins through smart contracts enables the bins to act as vending machines for crops. Crop buyers would be able to see inventory levels and make bids for the crops, and when the bid is accepted, the ledger generates a contract and the buyer executes it. This transaction can occur with little to no human interaction between the producers and buyers while maintaining a secure ledger for the transactions and transfer of assets and data. An example would be a larger producer with many bins spread across the countryside who could sell crops from those bins to be picked up by the buyer in manned and unmanned transport machines.

In addition to the tracking of data, the present invention further contemplates the creation of a market in which a premium is paid to farmers by making carbon emission-related data relative to their crops usable, presentable, and marketable to buyers like cooperatives, mills, and ethanol plants. For example, the present invention may provide for minting non-fungible tokens, either dynamic or static, representing ownership of carbon emission-related data, and enabling a market for transactions involving such tokens.

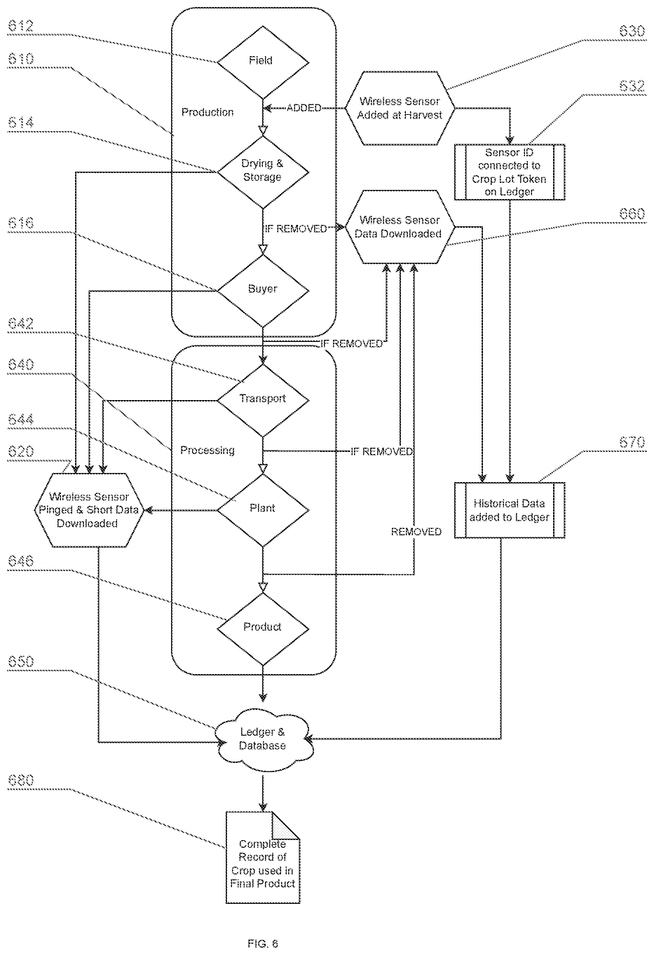

FIGS. 5-8 illustrate various aspects of the integration of such a blockchain-based ledger (or other technology), and how data written to such a ledger may be tokenized and utilized, in the present invention. FIG. 5 is a flow chart that illustrates how data tracked and stored on a ledger 510 or similar technology may be used in a crop supply chain. Information about seed or crop variety 520 may be obtained from the ledger 510, and used in a production environment 530 that includes field activities 532, drying and storage activities 534, and providing a crop to a post-harvest, post-drying market 536 to one or more buyers. Field applications 540 that may utilize data stored on the ledger 510 include for example, tillage practices, planting of cover crops, etc. Information relative to the drying and storage process 550 includes an amount of fuel, electricity usage, health of drying and storage systems, remaining allowable storage time, etc. Information 560 relative to markets and buyers 536 includes a value of the crop, a distance to market, contract details, etc. All of this information may be stored on and derived from other information obtained from a ledger 510.

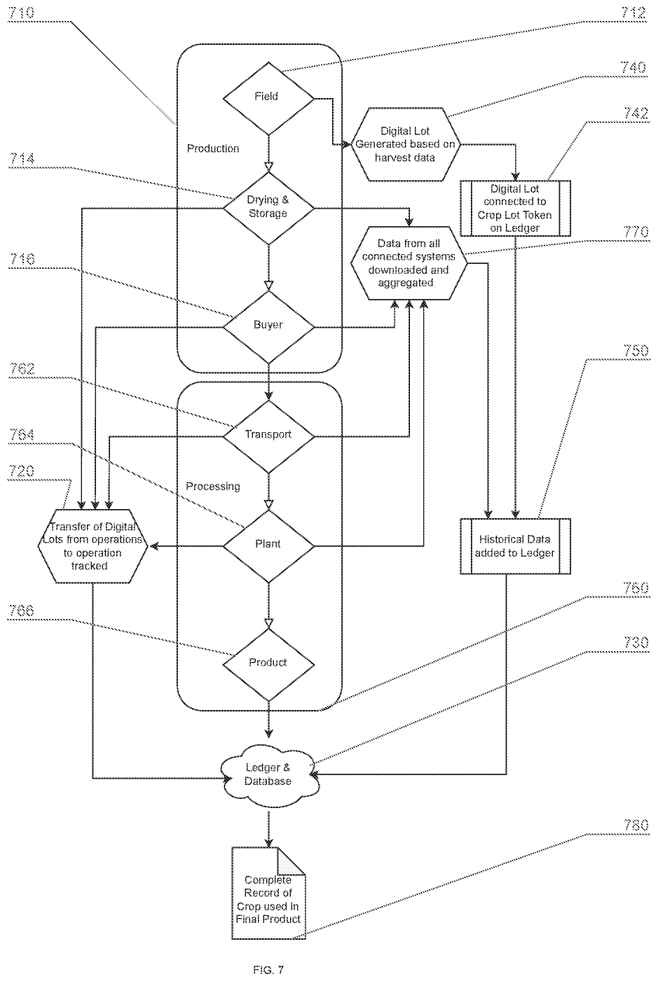

FIG. 6 is a flow chart showing the tracking, and data collecting points and functions, related to having transient sensors in a post-harvest crop as it moves through the supply chain. FIG. 6 illustrates a production block 610, comprised at least of field 612, drying and storage 614, and market/buyer 616 phases. Wireless, transient sensors are interrogated at desired intervals, and short-term data 620 is downloaded from such sensors; in the embodiment of FIG. 6, transient sensors 630 are added after a crop has been harvested. The sensor ID 632, connected to a crop lot token on the ledger 650, is obtained and added to historical data 670 and written to the ledger 650. A processing block 640 includes a transport phase 642, a plant/processing phase 644, and a production phase 646 (representing a finished product using the crop). Data from the transport phase 642 and the plant/processing phase 644 is also downloaded from transient sensors. The information collected from the sensors 620 is provided to a ledger 650, and maintained and utilized as part of the complete record 680 of the crop used in a final product.

When transient sensors are removed from any phase of the production block 610 or the processing block 640, all data 660 is downloaded, and historical data 670 is written to the ledger 650. Again, this data 670 is maintained and utilized as part of the complete record 680 of the crop used in a final product.

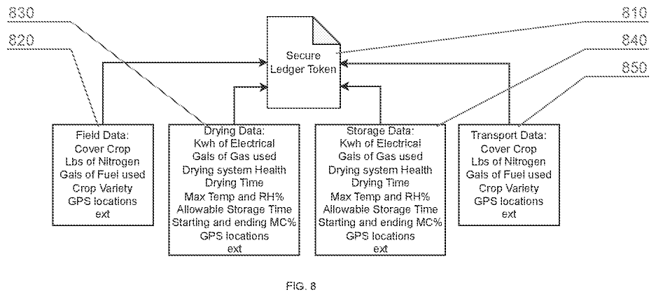

FIG. 7 is a flow chart showing the tracking, and data collecting points and functions, related to the creation of a connected supply chain without the use of physical, wireless transient sensors. FIG. 7 illustrates a production block 710, comprised at least of field 712, drying and storage 714, and market/buyer 716 phases. Without wireless sensors, there is a transfer 720 of digital lot information relative to the drying and storage 714, and market/buyer 716 phases, for the tracking of operations; this information is written to ledger 730, and maintained and utilized as part of the complete record 780 of the crop used in a final product.

In the embodiment of FIG. 7, a digital lot 740 is generated based on harvest data relative to the field phase 712, and this information is connected to a crop lot token 742 that is obtained and added to historical data 750 and written to the ledger 730. A processing block 760 includes a transport phase 762, a plant/processing phase 764, and a production phase 766 (representing a finished product using the crop). Data from all connected systems is downloaded and aggregated at step 770, and historical data 750, which is then written to the ledger 730, and maintained and utilized as part of the complete record 780 of the crop used in a final product.

FIG. 8 is a flow chart illustrating types of data that is stored in a secure ledger and tokenized in one or more non-fungible tokens 810 in smart contract(s) within a blockchain-based environment or other similar technology. Types of data that are tokenized in the framework of the present invention include field data 820, which may include, for example, cover crop information such as pounds of nitrogen used, gallons of fuel used, crop variety planted, and geographical positioning system data points representing a location of the planted cover crop. Tokenized data may also include drying data 830, which includes information such as for example amount of electricity used, amount of fuel used, drying system health, drying time, maximum values of temperature and relative humidity, allowable storage time, starting and ending moisture content values, and geographical positioning system data points representing a location of the drying systems used.

Tokenized data may also include storage data 840, which includes information such as for example amount of electricity used, amount of fuel used, drying system health, drying time, maximum values of temperature and relative humidity, allowable storage time, starting and ending moisture content values, and geographical positioning system data points representing a location of the storage systems used. Additionally, tokenized data may further include transport data 850, which includes, for example, cover crop information such as pounds of nitrogen used, gallons of fuel used, crop variety planted, and geographical positioning system data points representing transportation routes and locations.

### Neural Network Language

As noted above, the machine learning-based models may incorporate one or more neural networks. Neural networks generally are comprised of nodes, which are computational units having one or more biased input/output connections. Such biased connections act as transfer (or activation) functions that combine inputs and outputs in some way. Nodes are organized into multiple layers that form the neural network. There are many types of neural networks, which are computing systems that “learn” to perform tasks, without being programmed with task-specific rules, based on examples.

Neural networks generally are based on arrays of connected, aggregated nodes (or, “neurons”) that transmit signals to each other in the multiple layers over the biased input/output connections. Connections, as noted above, are activation or transfer functions which “fire” these nodes and combine inputs according to mathematical equations or formulas. Different types of neural networks generally have different configurations of these layers of connected, aggregated nodes, but they can generally be described as an input layer, a middle or ‘hidden’ layer, and an output layer. These layers may perform different transformations on their various inputs, using different mathematical calculations or functions. Signals travel between these layers, from the input layer to the output layer via the middle layer, and may traverse layers, and nodes, multiple times.

Signals are transmitted between nodes over connections, and the output of each node is calculated in a non-linear function that sums all of the inputs to that node. Weight matrices and biases are typically applied to each node, and each connection, and these weights and biases are adjusted as the neural network processes inputs and transmits them across the nodes and connections. These weights represent increases or decreases in the strength of a signal at a particular connection. Additionally, nodes may have a threshold, such that a signal is sent only if the aggregated output at that node crosses that threshold. Weights generally represent how long an activation function takes, while biases represent when, in time, such a function starts; together, they help gradients minimize over time. At least in the case of weights, they can be initialized and change (i.e., decay) over time, as a system learns what weights should be, and how they should be adjusted. In other words, neural networks evolve as they learn, and the mathematical formulas and functions that comprise neural networks design can change over time as a system improves itself.

The application of neural networks within the data modeling aspects of the framework described herein may include instantiations of different networks for different purposes. These include both “production” neural network(s), configured to refine the algorithms performed within the overall modeling framework to generate output data, and “training” neural network(s), configured to train the production network(s) using improvements on the reasons for prior, historical outcomes that have been learned.

Neural networks can also incorporate a time delay, or feedback loop, which is calculated to generally account for temporal dependencies, to further improve the results of the modeling framework. This may be used by a particular type of neural network that accounts for timed data sequences, such as for example the Long-Short-Term-Memory (LSTM) neural network, discussed above. Feedback loops and other time delay mechanisms applied by the various mathematical functions of such a neural network are modeled after one or more temporally-relevant characteristics, and incorporate calculated weights and biases for variables depending on the input data collected and type of problem being analyzed.

Neural networks may be configured to address the problem of decay in longer time-dependent sequences in an architecture that has multiple, interactive components acting as “blocks” in place of the conventional layers of the neural network. Each of these blocks may represent a single layer in that middle layer, or may form multiple layers; regardless, each block may be thought of as representing different timesteps in a time-dependent sequence analysis of input data.

The components of such a specially-focused neural network form its internal state and include a cell, which acts as the memory portion of the block, and three regulating gates that control the flow of information inside each block: an input gate, an output gate, and a forget gate. The cell remembers values over arbitrary time intervals, by keeping track of the dependencies between elements in an input sequence, and the three gates regulate the flow of information into and out of the cell. The input gate controls the extent to which a new value flows into the cell, the forget gate controls the extent to which a value remains in the cell, and the output gate controls the extent to which the value in the cell is used to compute the output of the block. The decision-making function of these gates is often referred to as the logistic sigmoid function for computing outputs of gates in these types of neural networks. There are connections into and out of these gates, and at least the weights of these connections, which need to be learned during training, determine how the gates operate.

Inside neural network blocks, there are additional layers that perform the activation functions needed to ensure that time-dependent data sequences are properly analyzed to avoid decay. One such activation function that may be incorporated is a tanh layer, which effectively classifies input data by determining which input values are added to the internal state of the block. Input gates are a layer of sigmoid-activated nodes whose output is multiplied by inputs classified by preceding tanh layers. The effect of these activation functions is to filter any elements of the inputs that are not required, based on the values assigned to each node for the problem being analyzed, and the weights and biases applied. The weights applied to connections between these nodes can be trained to output values close to zero to switch off certain input values (or, conversely, to pass through other values). Another internal state of a block, the forget gate, is effectively a feedback loop that operates to create a layer of recurrence that further reduces the risk of decay in time-dependent input data. The forget gate helps the neural network learn which state variables should be “remembered” or “forgotten”.

Supervised learning is an application of mathematical functions in algorithms that classify input data to find specific relationships or structure therein that allow the machine learning prediction engine to efficiently produce highly accurate output data. There are many types of such algorithms for performing mathematical functions in supervised learning approaches. These include regression analysis (including the logistic regression discussed above, and polynomial regression, and many others), decision trees, Bayesian approaches such as naive Bayes, support vector machines, random forests, anomaly detection, etc.

Neural networks are also a type of such supervised learning approaches, which may also include one or more of the computational techniques in the algorithms described above within their structures. Neural networks are more flexible than regression approaches, and allow for combinations of both structured data (e.g., sensor data) and unstructured data (e.g., observations discerned from social media feeds or direct user input) as inputs to produce the types of outputs desired.

Recurrent neural networks are a name given to types of neural networks in which connections between nodes follow a directed temporal sequence, allowing the neural network to model temporal dynamic behavior and process sequences of inputs of variable length. These types of neural networks are deployed where there is a need for recognizing, and/or acting on, such sequences. As with neural networks generally, there are many types of recurrent neural networks. These include, for example, fully recurrent neural networks, Hopfield networks, bi-directional associative memory networks, echo state networks, neural Turing machines, and many others, all of which exhibit the ability to model temporal dynamic behavior. Any instantiation of such neural networks in the present invention may include one or more of these types, and it is to be understood that neural networks applied within the machine learning prediction engine may include different ones of such types. Therefore, the present invention contemplates that many types of neural networks may be implemented, depending at least on the type of problem being analyzed.

As noted above, a support tool may be incorporated within, and may operate in conjunction with, the framework 100 of the present invention. Such a support tool may be configured to enable customized user operation and selection of various attributes for performing the framework 100, such as a specifying drying strategy and expected outcomes, (for example, conserving energy, expediting drying, or increasing maximum storage time). The support tool may also be used to monitor the performance of and calibrate the various elements of a stirator, as well as perform diagnostic functions thereon. Still further, the support tool may also be used to monitor sensor performance, calibrate and re-calibrate sensors, and perform any diagnostic functions on the sensors. The support tool may include a user interface to customize the input data or sensor data, as well as to modify performance of the modeling performed within the framework. In addition to desktop, laptop, and mainframe computing systems, users may access the support tool using applications resident on mobile telephony, tablet, or wearable computing devices.

The systems and methods of the present invention may be implemented in many different computing environments. For example, the various algorithms embodied in the data processing elements may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, GPU and any comparable means. Still further, the present invention may be implemented in cloud-based data processing environments, and where one or more types of servers are used to process large amounts of data, and using processing components such as CPUs (central processing units), GPUs (graphics processing units), TPUs (tensor processing units), and other similar hardware. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors or general processing units), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be wholly or partially implemented in software that can be stored on a non-transitory computer-readable storage medium, executed on programmed general-purpose computer with the cooperation of a controller and memory, a special purpose computer, a microprocessor, or the like. In these instances, the systems and methods of this invention can be implemented as a program embedded on a mobile device or personal computer through such mediums as an applet, JAVA® or CGI script, as a resource residing on one or more servers or computer workstations, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, machine learning, artificial intelligence, physically informed neural networks, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, the framework may be provided as a stand-alone software application or as software-as-a-service, independent of any hardware system, via one or more application programming interfaces. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
receiving, as input data, information collected from a plurality of sensors that are associated a) with auxiliary devices in one or more bin systems within or near a grain container, b) with one or more sections of a grain mass stored in the grain storage container, and c) with the grain storage container;
analyzing the input data in a plurality of data processing elements within a computing environment that includes one or more processors and at least one computer-readable non-transitory storage medium having program instructions stored therein which, when executed by the one or more processors, cause the one or more processors to execute the plurality of data processing elements for monitoring and controlling the bin systems, by:
developing a set of machine learning-based control models to estimate at least one manipulated variable representing a condition within the grain mass over time, wherein the set of machine learning-based control models include a testing model that is trained on historical data that includes additional variables representing characteristics of the grain mass, and validated by newly-collected input data that includes the additional variables, the testing model generating an estimated output at a specified time step representing a future time, and a production model configured to continuously adjust the testing model by measuring the estimated output at a time step representing a future time against a realized output as the time step occurs, and wherein the one or more machine learning-based models generate a system health profile representing both grain mass conditions and operational characteristics of the bin systems from the estimated output of the testing model, and
predicting the at least one manipulated variable for the grain mass from the system health profile; and
controlling an operation of the auxiliary devices in the one or more bin systems from the system health profile.

2. The method of claim 1, wherein the plurality of sensors that are associated with the grain storage container include one or more of fuel tank pressure sensors, line pressure sensors, amperage sensors, plenum pressure sensors, headspace sensors, and imaging sensors.

3. The method of claim 1, wherein the plurality of sensors associated with one or more sections of a grain mass stored in the grain container include static sensors or transient sensors that travel with the grain mass, the static sensors and transient sensors collecting information that represents one or more of relative humidity, temperature, and carbon dioxide in the grain mass.

4. The method of claim 1, wherein the at least one manipulated variable representing the condition within the grain mass over time is one or both of a moisture content of the grain mass and a drying rate of the grain mass.

5. The method of claim 1, wherein the auxiliary devices in the one or more bin systems include a fan, a burner, a vapor solenoid, and a modulating valve, and wherein the controlling the operation of the auxiliary devices in the one or more bin systems from the system health profile includes one or more of controlling a fan speed, controlling a fan power, controlling a burner rate, controlling a burner power, controlling the vapor solenoid, and controlling the modulating valve.

6. The method of claim 1, wherein the in-bin system is a stirator having one or more augers that move within the grain storage container to agitate the grain mass.

7. The method of claim 6, wherein the controlling the operation of the bin system includes at least one of controlling an auger speed, controlling an auger position, controlling a rotational arm speed of the stirator, controlling a fan state, controlling a fan speed, and controlling a burner temperature.

8. The method of claim 1, further comprising mapping the condition of the grain mass at an end of, or in close proximity to, the auxiliary devices as the auxiliary devices traverse through the grain mass, and wherein a location of augers, the location of the transient sensors, and the location of the sensors coupled to augers or other auxiliary devices, are triangulated by one or more controllers using the system health profile, to generate a map of the grain within the container.

9. The method of claim 1, further comprising writing one or more data elements comprising the system health profile to a distributed ledger, and accessing the distributed ledger to perform one or more of monitoring the system health of the bin, initiating a reorder of parts for the in-bin systems, reporting conditions of the grain mass, and reporting conditions of the in-bin systems.

10. A system, comprising:
a data collection element configured to receive input data comprised of information collected from a plurality of sensors that are associated a) with auxiliary devices in one or more bin systems within or near a grain container, b) with one or more sections of a grain mass stored in the grain storage container, and c) with the grain storage container; and
a system health model configured, within a computing environment that includes one or more processors and at least one computer-readable non-transitory storage medium having program instructions stored therein which, when executed by the one or more processors, cause the one or more processors to execute a plurality of data processing elements to monitor and control the bin systems, by:
estimating at least one manipulated variable representing a condition within the grain mass over time, in a set of machine learning-based control models that include a testing model that is trained on historical data that includes additional variables representing characteristics of the grain mass, and validated by newly-collected input data that includes the additional variables, the testing model generating an estimated output at a specified time step representing a future time, and a production model configured to continuously adjust the testing model by measuring the estimated output at a time step representing a future time against a realized output as the time step occurs,
generating a system health profile representing both grain mass conditions and operational characteristics of the bin systems from the estimated output of the testing model, and
predicting the at least one manipulated variable for the grain mass from the system health profile; and
wherein an operation of the auxiliary devices in the one or more bin systems is controlled based on the system health profile.

11. The system of claim 10, wherein the plurality of sensors that are associated with the grain storage container include one or more of fuel tank pressure sensors, line pressure sensors, amperage sensors, plenum pressure sensors, headspace sensors, and imaging sensors.

12. The system of claim 10, wherein the plurality of sensors associated with one or more sections of a grain mass stored in the grain container include static sensors or transient sensors that travel with the grain mass, the static sensors and transient sensors collecting information that represents one or more of relative humidity, temperature, and carbon dioxide in the grain mass.

13. The system of claim 10, wherein the at least one manipulated variable representing the condition within the grain mass over time is one or both of a moisture content of the grain mass and a drying rate of the grain mass.

14. The system of claim 10, wherein the auxiliary devices in the one or more bin systems include a fan, a burner, a vapor solenoid, and a modulating valve, and wherein the controlling the operation of the auxiliary devices in the one or more bin systems from the system health profile includes one or more of controlling a fan speed, controlling a fan power, controlling a burner rate, controlling a burner power, controlling the vapor solenoid, and controlling the modulating valve.

15. The system of claim 10, wherein the in-bin system is a stirator having one or more augers that move within the grain storage container to agitate the grain mass.

16. The system of claim 15, wherein a control of the operation of the bin system includes at least one of control of an auger speed, control of an auger position, control of a rotational arm speed of the stirator, control of a fan state, control of a fan speed, and control of a burner temperature.

17. The system of claim 10, wherein the system health model is further configured to map the condition of the grain mass at an end of, or in close proximity to, the auxiliary devices as the auxiliary devices traverse through the grain mass, and
wherein a location of augers, the location of the transient sensors, and the location of the sensors coupled to augers or other auxiliary devices, are triangulated by one or more controllers using the system health profile, to generate a map of the grain within the container.

18. The system of claim 10, wherein one or more data elements comprising the system health profile are written to a distributed ledger, and wherein the distributed ledger is accessed to perform one or more of monitoring the system health of the bin, initiating a reorder of parts for the in-bin systems, reporting conditions of the grain mass, and reporting conditions of the in-bin systems.

19. A method, comprising:
estimating at least one manipulated variable representing a condition within a grain mass over time to monitor and control an operation of one or more bin systems comprised of auxiliary devices and within or near a grain storage container, in a set of machine learning-based control models that analyze input data comprised of information collected from a plurality of sensors that are associated a) with the auxiliary devices in the one or more bin systems within the grain container, b) with one or more sections of a grain mass stored in the grain storage container, and c) with the grain storage container, the set of machine learning-based control models including a testing model that is trained on historical data that includes additional variables representing characteristics of the grain mass, and validated by newly-collected input data that includes the additional variables, the testing model generating an estimated output at a specified time step representing a future time, and a production model configured to continuously adjust the testing model by measuring the estimated output at a time step representing a future time against a realized output as the time step occurs;
generating a system health profile representing both grain mass conditions and operational characteristics of the bin systems from the estimated output of the testing model; and
predicting the at least one manipulated variable for the grain mass from the system health profile,
wherein the operation of the auxiliary devices in the one or more bin systems is controlled based on the system health profile.

20. The method of claim 19, wherein the plurality of sensors that are associated with the grain storage container include one or more of fuel tank pressure sensors, line pressure sensors, amperage sensors, plenum pressure sensors, headspace sensors, and imaging sensors.

21. The method of claim 19, wherein the plurality of sensors associated with one or more sections of a grain mass stored in the grain container include static sensors or transient sensors that travel with the grain mass, the static sensors and transient sensors collecting information that represents one or more of relative humidity, temperature, and carbon dioxide in the grain mass.

22. The method of claim 19, wherein the at least one manipulated variable representing the condition within the grain mass over time is one or both of a moisture content of the grain mass and a drying rate of the grain mass.

23. The method of claim 19, wherein the auxiliary devices in the one or more bin systems include a fan, a burner, a vapor solenoid, and a modulating valve, and wherein the controlling the operation of the auxiliary devices in the one or more bin systems from the system health profile includes one or more of controlling a fan speed, controlling a fan power, controlling a burner rate, controlling a burner power, controlling the vapor solenoid, and controlling the modulating valve.

24. The method of claim 19, wherein the in-bin system is a stirator having one or more augers that move within the grain storage container to agitate the grain mass.

25. The method of claim 24, wherein a control of the operation of the bin system includes at least one of controlling an auger speed, controlling an auger position, controlling a rotational arm speed of the stirator, controlling a fan state, controlling a fan speed, and controlling a burner temperature.

26. The method of claim 19, further comprising mapping the condition of the grain mass at an end of, or in close proximity to, the auxiliary devices as the auxiliary devices traverse through the grain mass, and wherein a location of augers, the location of the transient sensors, and the location of the sensors coupled to augers or other auxiliary devices, are triangulated by one or more controllers using the system health profile, to generate a map of the grain within the container.

27. The method of claim 19, further comprising writing one or more data elements comprising the system health profile to a distributed ledger, and accessing the distributed ledger to perform one or more of monitoring the system health of the bin, initiating a reorder of parts for the in-bin systems, reporting conditions of the grain mass, and reporting conditions of the in-bin systems.
